(19) United States
(12) Patent Application Publication
(10) Pub. No.: US 2010/0025353 A1
(43) Pub. Date: Feb. 4, 2010

(54) METHOD FOR COATING SOME AREAS OF HOLLOW ELEMENTS

(75) Inventor: Robert Siegl, Dornbirn (AT)

Correspondence Address: MORRISS OBRYANT COMPAGNI, P.C., 734 EAST 200 SOUTH, SALT LAKE CITY, UT, 84102, US

(73) Assignee: ALPLA WERKE ALWIN LEHNER GMBY & CO., KG, Hard (AT)

(21) Appl. No.: 12/524,768

(22) PCT Filed: Jan. 9, 2008
(86) PCT No.: PCT/EP08/00092

§ 371 Date: Jul. 28, 2009

(30) Foreign Application Priority Data
Jan. 31, 2007 (CH) 00162/07

(51) Int. Cl. B65D 23/08; B05D 5/00; B65D 1/02

(52) U.S. Cl. 215/12.2; 427/256

(57) ABSTRACT

It is proposed to transport a hollow body, after manufacture thereof, by a roller coating means (10) in which its outer surface (7) is provided in certain regions with a coating. In this case, the coating is not applied to the neck portion (5) and the interior of the hollow body. The hollow body can be a preform for a stretch blow moulded plastics material bottle or a fully blow moulded plastics material bottle.

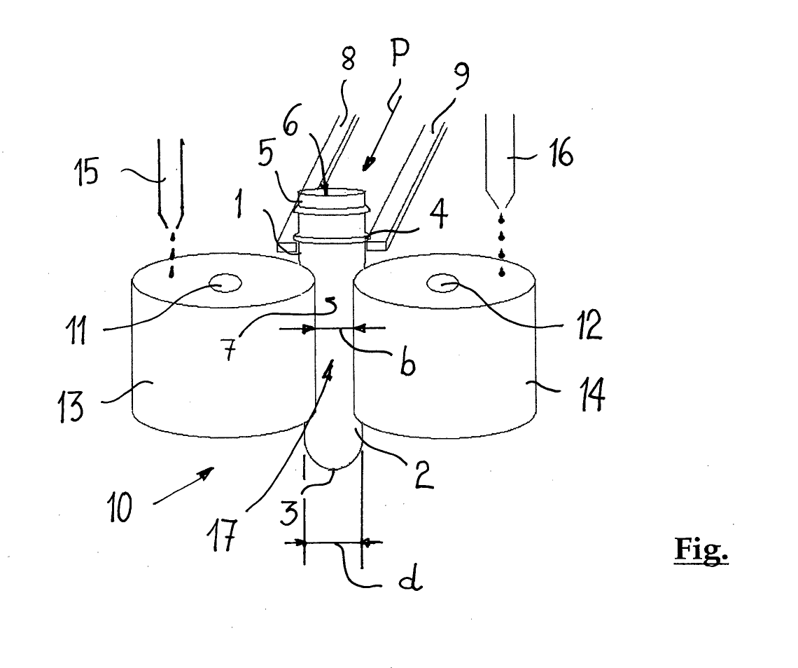

### CROSS-REFERENCE TO RELATED APPLICATIONS

This application claims priority to PCT/EP2008/000092 filed on Jan. 9, 2008 and CH00162/07 filed on Jan. 31, 2007, the entirety of each of which is incorporated by this reference.

### BACKGROUND OF THE INVENTION

1. Field of the Invention

The invention relates to a method for coating certain regions of a hollow body having an elongate rotationally symmetrical body with a bottom at one end and a nech portion at the other end.

2. State of the Art

A large number of the plastics material bottles and similar containers currently used are manufactured by stretch blow moulding. In this method, what is known as a preform, which usually possesses an elongate, tubular shape, has at its one longitudinal end a bottom and at the other longitudinal end a neck region with shaped threaded portions or the like, is inserted into a moulding cavity of a blowing mould and inflated by a medium which is blown in at excess pressure. In this case, the preform is additionally stretched in the axial direction by a stretching mandrel retracted through the neck opening. After the stretching/blowing process, the finished plastics material bottle is removed from the blowing mould.

The single-layered or multilayered preform is manufactured, prior to the stretch blow moulding, in a separate plastics material injection moulding method or in a plastics material extrusion method. The preforms can be manufactured immediately before the stretch blow moulding. However, in many cases, the preforms are manufactured separately in space and time from the stretch blow moulding and temporarily stored for later use. During the later stretch blow moulding, the preforms are reheated and the plastics material bottles manufactured therefrom.

The plastics materials used for the manufacture of the plastics material bottles, usually polyethylene terephthalate (PET), have relatively poor sliding properties. This impedes transportation, which is conventionally carried out via conveyor belts and sliding rails, of the preforms produced in the injection moulding process. In the stretch blow moulding machine itself, the preforms are also separated via conveyor belts and sliding rails and transported to the blowing stations. During transportation and in particular during storage of the preforms, the preforms enter into abutment against one another. As a consequence of the unfavourable surface properties, the preforms almost cling to one another. During the decanting into a transportation and storage container, only poor use is made, owing to the poor sliding properties of the preforms, of the available volume. In addition, the transportation and the deposition of the preforms into the containers can lead to damage, scratches, adhesive points or the like in the surfaces of the preforms, which are then visible on the fully stretch blow moulded plastics material bottles. Although these surface defects do not usually impair the mechanical properties of the walls of the bottles, they are in many cases visually unacceptable. Furthermore, the poor sliding properties of the preforms can lead during the stretch blow moulding process to the plastics material not sliding in an optimum manner over the inner surfaces of the cavity of the blowing mould, and either inaccessible corners and edges cannot be shaped or the wall thickness of the shaped plastics material bottle is too low at these points.

It is already known in the prior art to provide the preforms with a friction-reducing coating in a dipping bath. Afterwards, the preforms are put down in order to dry the coating. After the drying of the coating, the preforms are further transported and stored. During the dip coating, quite a lot of coating material is applied to the preforms, and a part of the coating drips off again. Therefore, the preforms have to remain in the coating station for a relatively long time in order to avoid the risk of soiling the transportation paths.

A method is also already known in which the preforms are provided with a coating shortly before or only after depositing into the storage containers. For this purpose, the coating is poured or sprayed over the preforms from a coating means arranged above the plane of transportation of the preforms. The coating is then dried within the storage container. This form of coating leads to relatively non-uniform results. Obscured regions of the preforms are for example coated not at all or only insufficiently.

In the known methods, it can occur that the coating also enters the region of the opening in the preforms and even the interior of the preforms. This is undesirable in particular in bottles for food products, as the coating can impair the taste of the fill goods. The circumstance that the coating can also enter regions in which it can enter into contact with the subsequent fill goods severely restricts the selection of the coating materials in the known coating methods. In particular, it is necessary to ensure that the coatings cannot be detrimental to health.

The coating of preforms is also proposed for increasing the suitability for storage of fill goods, for example of beer, decanted into the plastics material bottles made from the preforms. For this purpose, the preforms are provided on their outer side in relatively complex spray coating methods or plasma coating methods with one or more layers which are intended to serve, in particular, as a gas barrier. These coating methods too have the problem that the coating material can also be deposited in the interior of the preform. In addition, the coating methods used always lead to soiling of the environment with coating material. Therefore, increased effort must be made to restrain the coating material. This leads to a significant increase in the costs of manufacturing the preform, which, in the case of preforms manufactured in very large quantities, are not inconsiderable.

An advantage of the present invention is therefore to provide a method for coating hollow bodies, in which the surface of its rotationally symmetrical body can be provided with a coating without thereby soiling the environment with coating material. In this case, care should be taken to ensure that no coating materials are deposited in regions of the hollow body that can enter into contact with fill goods which are subsequently decanted therein. It should be possible to apply the coating in a simple and economical manner. Complex restraining means, suction extractors, coating chambers and devices of this type are to be avoidable. The coating method is to be equally suitable for preforms for the manufacture of stretch blow moulded plastics material bottles, for example PET bottles, as for plastics material bottles which have already been fully blow moulded and have a rotationally symmetrical body. In a particular variant embodiment of the invention, the new method is intended to allow preforms to be coated in such a way as to allow simple transportation and damage-free storage of the preforms. Ideally, a method variant is also to be provided allowing the manufacture of bottle geometries, the edges and corners of which could in the past be shaped either not at all or only with an excessively low wall thickness.

### SUMMARY OF THE INVENTION

These advantages are achieved by a method for coating hollow bodies in certain regions, such as for example preforms for stretch blow moulded plastics material bottles or fully blow moulded plastics material bottles having a rotationally symmetrical body. Developments and/or advantageous variant embodiments of the invention form the subject-matter of the dependent claims.

The invention proposes that the hollow body be transported, after manufacture thereof, by a roller coating means in which the outer surface of its rotationally symmetrical body is provided with a coating. In this case, the coating is not applied to the neck portion and the interior of the hollow body.

During the roller coating, the coating material is transferred directly from the rollers, which enter into contact with the outer surface to be coated of the rotationally symmetrical body of the hollow body, to the surface. The coating material is applied only in the regions provided therefor. There is no risk of deposition of coating material in other regions of the hollow body, in particular in regions which enter into contact with the fill goods. The amount of coating is very easy to adjust, so that the coating material is prevented from dripping off during the further transportation of the hollow body. This prevents soiling of the transportation section for the hollow bodies and other adjoining installation components. In contrast to spray coating installations or plasma coating installations, no complex installations are required for suction-extracting the spray mist of the coating material. Compared to dip or spray coating installations or even plasma coating installations, roller coating installations are very simple in their construction. They are very easy to integrate into existing production plants for preforms or plastics material bottles having a rotationally symmetrical body and allow economical coating of the hollow bodies with a broad range of coating materials. The sole condition for the coating materials is that it be possible to apply them in the liquid state.

In a variant of the method, the hollow body is transported by a roller coating means equipped with at least two rotatable application rollers for the coating material. The application rollers are arranged on both sides of a path of transportation of the hollow body and delimit a gap for passage of the hollow body, the width of which is smaller than an external diameter of the body in a portion adjoining the bottom of the container. The application rollers are provided with a resilient, sponge-like cover which is suitable for absorbing and dispensing the liquid coating material.

Two application rollers arranged along the path of transportation of the hollow body are the simplest embodiment of a roller coating means. The coating material is dripped onto or otherwise applied to the application rollers, in particular to the sponge-like covers. At the side of each application roller that is remote from the path of transportation, it is also possible to provide a doctor blade or the like which is used to remove excess coating material from the covers. The removed coating material is collected and returned to a storage container. This prevents the coating material from being cast off during the rotation of the application rollers. A preform, which is transported along and suspended for example from a transportation rail, enters the passage gap between the application rollers and is, as a result of the rotation thereof, likewise made to rotate. On account of the somewhat larger external diameter of the body of the preform, the sponge-like covers of the application rollers are pressed together. As a result, they rest snug, in the body portion to be coated, against the outer surface of the preform, and the coating material is dispensed effectively against the outer surface of the preform. The sponge-like covers of the application rollers are compressed during the coating process and stress-relieved again. The pumping movement resulting therefrom assists the absorption of the externally supplied coating material. The same applies to a plastics material bottle transported in a suspended or else in an upright state by the coating means.

If the rotating application rollers are arranged offset in the direction of transportation of the hollow body, during supplying of the hollow body rotational movement thereof is assisted, and the coating material can be applied very uniformly to the outer surface of the body of the hollow body.

In a further variant embodiment of the invention, which is used in particular also in conjunction with application rollers arranged in an offset manner, the application rollers are driven at differing speeds. As a result of the difference in speed of the application rollers, the hollow body can be made to rotate particularly easily about its longitudinal axis. The application rollers can in this case be rotated in opposite directions or have the same direction of rotation.

A variant of the invention provides for the hollow body to be a preform and to be provided with a friction-reducing coating. The friction-reducing coating reduces the risk of damage to the surface of the preforms. The coating ensures that the preforms can effectively slide against one another. This has advantages during separation of the preforms and during transportation thereof suspended from belts or in rail systems. On account of their improved sliding properties, the preforms are arranged in the storage containers in a more orderly state than without a coating. This prevents excessively large hollow spaces between the preforms, and the volume of the storage container is utilised more effectively.

As a result of the roller coating method, the entire process of manufacturing the preforms is simplified and shortened in terms of time. A longer step for drying the preforms may generally be dispensed with in the method according to the invention. The coating is not applied to the neck portion of the preform. It is also impossible for coating material to enter the interior of the preform. This prevents coating of regions of the preform that subsequently enter into contact, in the manufactured plastics material bottle, with the fill goods. The selection of coating materials which can be used is broadened as a result, and this can give rise to advantages in terms of cost. As a result of the improved sliding properties of the preform, the preblow which is generated can slide more effectively, during the subsequent stretch blow moulding, into the edges and corners of the blowing mould, and reaches even regions which could be reached, using the previous methods, only with difficulty or not at all. As a result, it is now also possible to manufacture more complex bottle geometries.

The coating applied to the preforms using the methods known in the prior art assumes over the course of time a solid state. This usually necessitates a separate drying step. In a variant embodiment of the method according to the invention, the preform is provided with a coating displaying a liquid state even after cooling of the preform to ambient temperature. Liquid films as coatings have the advantage that they are distributed more effectively on the surface and lead to a more homogeneous coating. The coating material, which is in a liquid state on the outer surface of the body of the preform, is automatically pressed against the inner wall of the blowing mould during the stretch blow moulding process. A part of the coating is left behind in the blowing mould and forms there a sliding film which wets even those points of the bottle that were previously not optimally wetted on the preform.

On account of the liquid state of the coating, the coating can still subsequently flow at a later point in time into less well-coated regions or into regions subjected to short-term, relatively high mechanical stresses. The distributing process is a dynamic process which is maintained over time. This is advantageous above all during relatively long storage of the preforms. The good sliding properties of the liquid films are therefore preserved even over a relatively long period.

As friction-reducing coating materials which maintain their liquid state, use is advantageously made substantially of material selected from the group comprising oils, esters, polyols, silicone oils and also mixtures of these and emulsions thereof. The aforementioned materials are known for their high reduction of friction and can very easily be applied to the surface of the preform at the desired thickness.

Another variant of the invention makes provision for the body of the hollow body, which can be a preform or a plastics material bottle, to be provided with a barrier layer which prevents the passage of CO₂ and O₂. This is advantageous, in particular, in hollow bodies in which it is possible to decant carbonated products or products which, like for example beer, can become oxidised as a result of oxygen entering the interior of the plastics material bottle and as a result lose quality.

The method according to the invention can be used for the single-layered or multilayered application of coating materials to the surface of the hollow body. A roller coating means for multilayered application has further application rollers which are each arranged in pairs on both sides of the part of transportation for the hollow bodies and each delimit a passage gap, the width of which is smaller than the diameter of the body in a portion adjoining the bottom of the container.

In the case of multilayered roller coating, the body of the hollow body can be coated with different coating materials. For example, firstly, one or more barrier layers are applied. Following that, a friction-reducing coating material can be applied as the outermost layer.

The hollow body is coated expediently at a layer thickness of from 2 μm to 100 μm.

Further advantages of the invention will emerge from the subsequent description of an exemplary variant embodiment of the invention with reference to the single schematic drawing which is a non-true-to-scale view of a preform in a roller coating means.

### BRIEF DESCRIPTION OF THE DRAWING

FIGURE is a perspective view of a hollow element conveyed through a roll coating apparatus in accordance with the principles of the present invention.

### DETAILED DESCRIPTION OF THE ILLUSTRATED EMBODIMENT

The sole FIGURE shows a preform 1 which is transported up to a roller coating means 10 via a rail system 8, 9. The preform 1 has a substantially cylindrical shape which is roughly the same shape as a test tube. A peripheral flange 4 divides the preform 1 into a neck portion 5 and into a cylindrical body 2 having a closed bottom 3. The neck portion 5 is conventionally provided with outer threaded portions (not shown in greater detail) and has an opening 6 leading into the interior of the preform 1. The preform 1 is manufactured for example by plastics material injection moulding or extrusion and can be single-layered or multilayered in its construction. Conventionally, it is made of polyethylene terephthalate PET or comparable plastics materials which can be used for stretch blow moulding. It is a precursor of what is known as a PET bottle which is made from the preform 1 in a subsequent stretch blow moulding method.

The preform is transported up to the roller coating means 10 via the rail system 8, 9 and transported through the coating means 10. In this case, it is supported with the underside of the peripheral flange 4 against the upper side of the two sliding rails 8, 9. The roller coating means 10 comprises two application rollers 11, 12 which are arranged on both sides of the path of transportation for the preform 1. The application rollers 11, 12 are for example arranged offset in the direction of transportation of the preform 1, which is indicated by the arrow P, and delimit a gap 17 for passage of the preform 1. The passage gap 17 has a width b which is smaller than an external diameter d of the body 2 of the preform in a portion adjoining the bottom 3. The application rollers 11, 12 are provided with resilient, sponge-like covers 13, 14 which are elastically deformable as the preform 1 passes between the application rollers 1, 2. The sponge-like covers are soaked with coating material via supply devices 15, 16 arranged above the application rollers 11, 12. At the side of the application rollers 11, 12 that is remote from the path of transportation 8, 9, doctor blades (not shown in greater detail) or similar wiping-off devices can be provided, which on the one hand distribute the coating material uniformly over the covers 13, 14 and on the other hand remove excess coating material from the covers 13, 14. The removed coating material is collected and returned to the covers 13, 14 of the application rollers 11, 12 via a storage container.

The application rollers 11, 12 are made to rotate about their axes via drives. In this case, the application rollers 11, 12 are rotated at differing speeds. The application rollers 11, 12 can be rotated in the same direction of rotation or in opposite directions of rotation.

As the preform 1 passes through the roller coating means 10, the preform is made to rotate about its longitudinal axis. The body 2, which has a larger diameter, of the preform 1 presses the sponge-like covers 13, 14 of the application rollers 11, 12 together, in each case in the region of abutment against its outer surface 7. The remaining regions of the covers 13, 14 return in each case to their starting state. The pumping movement resulting therefrom assists the soaking of the covers 13, 14 with the coating material. During passage through the roller coating means 10, the outer surface 7, which rests against the covers 13, 14 of the application rollers of the body 2 of the preform 1, is coated. The neck portion 6 and the interior of the preform 1 remain, on the other hand, free of coating material. Once the coating has been carried out, the preform 1 can be further transported to a stretch blow moulding device, or it is deposited into a storage container for later use.

For applying a plurality of coating layers, the roller coating means is equipped with further application rollers which are each arranged in pairs on both sides of the path of transportation of the preform and delimit a passage gap having corresponding dimensions. The application rollers are each equipped with means for supplying the coating material, via which the covers of the application rollers are soaked with the coating material. Each roller is provided with a drive means via which it can be made to rotate.

The roller coating means 10 is used for the application of barrier layers and/or of friction-reducing coatings. As barrier layers, use is made of materials which prevent CO₂ from escaping and/or O₂ from infiltrating. As the friction-reducing coating, use is advantageously made of materials which have a liquid state even after cooling of the preform 1. Suitable materials are for example oils, esters, polyols, silicone oils, mixtures of these and emulsions thereof

The coating of the preforms is applied at a thickness of from approximately 2 μm to approximately 100 μm.

The invention has been described based on the example of a roller coating for preforms for stretch blow moulded plastics material bottles. With only minor modifications of the roller coating means, the roller coating can also be carried out on plastics material bottles which have already been fully stretch blow moulded and have a rotationally symmetrical body. In this case, the plastics material bottles can likewise be transported in suspended form by the roller coating means. Alternatively, the plastics material bottles, which, in contrast to the preforms, have a relatively wide base, can also be transported, upright on a transportation belt, by the roller coating means. In this case, the neck portions of the plastics material bottles can additionally be guided in a guide gap.

1. Method for coating a hollow body, comprising:
providing an elongate rotationally symmetrical body having at its one longitudinal end a bottom and at its other longitudinal end a neck portion provided with a pouring opening; and
transporting the hollow body by a roller coating means in which the outer surface of its body is provided with a coating and the coating is not applied to the neck portion or the interior of the hollow body.

2. Method according to claim 1, characterised in that further comprising transporting the rotationally symmetrical hollow body by a roller coating means having at least two rotatable application rollers for the coating material, which are provided with a resilient, sponge-like cover and are arranged on both sides of a path of transportation of the hollow body, and delimit a gap for passage of the hollow body, the width of which is smaller than an external diameter of the body of the hollow body in a portion adjoining the bottom.

3. Method according to claim 2, further comprising arranging the application rollers to be offset in the direction of transportation of the hollow body.

4. Method according to claim 2, further comprising driving the application rollers at differing speeds.

5. Method according to claim 2, further comprising rotating the application rollers in opposite directions.

6. Method according to claim 2, further comprising rotating the application rollers (11, 12) in the same direction of rotation.

7. Method according to claim 1, further comprising manufacturing the hollow body from a preform which is manufactured by plastics material injection moulding or extrusion for manufacturing a plastics material bottle in a stretch blow moulding process having a substantially cylindrical body and a neck portion which adjoins a peripheral flange and is provided with a pouring opening, and in that the outer surface of the body of the preform is provided with a friction-reducing coating.

8. Method according to claim 7, further comprising providing the preform with a coating which maintains a liquid state after cooling of the preform to ambient temperature.

9. Method according to claim 8, further comprising coating the preform with a coating material selected from the group comprising oils, esters, polyols, silicone oils, and mixtures and emulsions thereof.

10. Method according to claim 1, further comprising providing the hollow body with a barrier layer which prevents the passage of CO₂ and O₂.

11. Method according to claim 10, further comprising providing the hollow body as a preform for the manufacture of stretch blow moulded plastics material bottles or as a plastics material bottle.

12. Method according to claim 1, further comprising transporting the hollow body by a roller coating means in which the outer surface of its body is successively coated with a plurality of layers.

13. Method according to claim 12, further comprising successively coating the outer surface of the hollow body with different coating materials.

14. Method according to claim 1, further comprising coating the hollow body at a layer thickness of from 2 μm to 100 μm.

15. Preform for manufacturing plastics material bottles comprising:
a substantially cylindrical body which is closed on one side and has a neck portion adjoining a peripheral flange and having a pouring opening; and
a coating applied by roller coating to the body, extending below the flange of the preform.

16. Preform according to claim 15, wherein the perform forms a PET bottle by stretch blow moulding.
